(19) United States
(12) Patent Application Publication
(10) Pub. No.: US 2021/0229930 A1
(43) Pub. Date: Jul. 29, 2021

(54) DELIVERY ITEM SORTING MACHINE

(71) Applicant: United States Postal Service, Washington, DC (US)

(72) Inventors: Thomas C. Potter, Oak Hill, VA (US); Daniel Mark, Sterling, VA (US)

(21) Appl. No.: 17/160,555

(22) Filed: Jan. 28, 2021

Related U.S. Application Data
(60) Provisional application No. 62/966,637, filed on Jan. 28, 2020.

(51) Int. Cl. B65G 47/26; B65G 47/31; B65G 47/49

(52) U.S. Cl. CPC B65G 47/261; B65G 2201/0285; B65G 47/49; B65G 47/31

(57) ABSTRACT

A sorting machine can include an output bin that includes a transport belt to transport a delivery item (e.g., a letter) from a distribution belt at a first speed. The output bin can include a braking roller to reduce the speed of the delivery item by operating at a second tangential speed that is slower than the first speed. The output bin can also include an auger assembly to apply a force to move at least the trailing portion of the item in a manner that clears the path to the braking roller for additional delivery items. The output bin can also include a bumper pad to stop the delivery item, where the delivery item is stopped against the bumper pad after being slowed down by contact with the braking roller. The slowed speed causes the delivery item to come to rest approximately in alignment with additional delivery items.

### CROSS-REFERENCE TO RELATED APPLICATIONS

This application claims the benefit of, and priority to, U.S. Provisional Patent Appl. No. 62/966,637 filed 28 Jan. 2020, which is hereby incorporated by reference in its entirety.

### BACKGROUND

Delivery items, such as envelopes, books, packages, flats, and the like, can be distributed and sorted using a variety of different devices. For example, delivery items can be routed through a sorting machine (e.g., a letter/envelope mail sorting machine or the like) to destination output bins. In some examples, the delivery items are routed based on data, such as sort plan data, which indicates whether an actuator is to move a diverter to force or direct delivery items into particular output bins of the sorting machine. In some examples, the delivery items can be traveling at 4 meters per second, or any other suitable speed. The various belts of the sorting machine can be timed so that each of the belts are travelling at 4 meters per second. This allows the delivery items to enter the output bin at the same speed (e.g., 4 m/s) as the belts are moving, therefore having a certain amount of momentum. The delivery items can move through the output bin via various belts and an auger assembly that directs the delivery items to a bumper pad, which stops the delivery items.

The bumper pad can serve as a shock absorber to prevent the fast-moving delivery items from bouncing back. In some examples, the bumper pad can prevent delivery items from stacking improperly, or prevent heavier taller items from flipping or changing orientation in relation to previous or subsequent delivery items deposited into the output bin. In some examples, after the delivery items contact a bumper pad, the delivery items remain proximate to the bumper pad in a fixed position until the next delivery item enters the output bin. This cycle can continue until the output bin cannot store or hold any additional delivery items. However, differences in the size and weight of various delivery items causes difficulties with obtaining a repeatable uniform stack in the output bin. In particular, the different momentums of the delivery items as the delivery items strike the bumper pad can cause the delivery items to change orientations, which results in a stack of delivery items with unaligned edges.

The devices and techniques described herein enable a sorting machine to reduce the momentum of the delivery items (e.g., envelopes, letters, etc.) to provide better control for positioning and aligning the delivery items into a stacked position or uniform row. Accordingly, the devices and techniques described herein provide an enhanced sorting machine that can produce a stack of delivery items with substantially aligned edges.

### BRIEF SUMMARY

This summary is intended to introduce a simplified encapsulation of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is to present one or more concepts in simplified form as a prelude to the detailed description below.

The foregoing and/or other aspects and utilities embodied in the present disclosure may be achieved by providing a sorting machine for delivery items, such as envelopes, etc., wherein the sorting machine includes an output bin that includes a transport belt to transport a delivery item from a distribution belt toward an auger assembly at a first predetermined speed. The output bin can also include the auger assembly to apply a force(s) to the delivery item, where at least one of the force(s) may be approximately perpendicular to the direction of travel of the delivery item. The auger assembly and/or the item's momentum may transport the delivery item from the transport belt toward a braking roller and the braking roller may reduce a speed of the delivery item by operating at a second predetermined tangential speed that is slower than the first predetermined speed. Furthermore, the output bin can include a bumper pad to stop a motion of the delivery item, wherein the delivery item is stopped against the bumper pad following contact with the braking roller, and wherein the delivery item is stopped approximately in alignment with additional delivery items.

In some embodiments, the delivery item (e.g., letter, envelope, etc.) sorting machine can include a transport roller and a braking roller belt operably coupled to the braking roller and the transport roller, wherein the braking roller belt is to rotate the braking roller at the second predetermined tangential speed. In some examples, the sorting machine can include a guide bracket to guide the delivery item from the transport belt to the braking roller. In various implementations, the braking roller protrudes from the sorting machine above the guide bracket. In some embodiments, the guide bracket is coupled to the braking roller via one or more circular ends. In some examples, the sorting machine can include a transport roller and an auger belt operably coupled to the auger assembly and the transport roller. The auger assembly can include an auger and the auger belt can be configured to drive the auger.

In some embodiments, the sorting machine can include a bracket assembly comprising one or more pulleys operably coupled to the auger belt. In some examples, the sorting machine can include a distribution belt and a secondary belt proximate the transport belt, wherein the secondary belt and the transport belt transport the delivery item from the distribution belt toward and/or past the auger assembly. In various implementations, the sorting machine can include a diverter that diverts the delivery item from a distribution belt to the output bin.

In some embodiments, a method for sorting delivery items with a sorting machine can include transporting, via a transport belt, a delivery item from a distribution belt to an auger assembly at a first predetermined speed. The method can also include applying, via the auger assembly, one or more forces to the delivery item, where at least one of the forces may cause the trailing portion of the item to move or bend away from a braking roller, and/or cause to item to assume or maintain a perpendicular position to the edge of the output bin. The auger assembly and/or the item's momentum may transport the delivery item from the transport belt toward the braking roller. The method may include operating the braking roller at a second predetermined tangential speed that is slower than the first predetermined speed. Furthermore, the method can include reducing a speed of the delivery item by contact with the braking roller, and stopping, via a bumper pad, the delivery item, wherein the delivery item is approximately in alignment with additional delivery items.

In various implementations, a sorting machine can include a diverter that directs a delivery item from a distribution belt into an output bin, wherein the output bin comprises a transport belt to transport the delivery item from the distribution belt toward an auger assembly at a first predetermined speed. The output bin can also include the auger assembly to apply a force(s), to the delivery item, which may push the trailing edge or portion of the item away from a braking roller. The auger assembly and/or the item's momentum may transport the delivery item from the transport belt toward the braking roller, wherein the auger assembly is operably coupled to an auger belt and a transport roller. Additionally, the output bin can include the braking roller to reduce a speed of the delivery item by operating at a second predetermined tangential speed that is slower than the first predetermined speed, the braking roller comprising an extruding mounting post that is connected to the braking roller via a braking roller belt. Furthermore, the output bin can include a bumper pad to stop the delivery item, wherein the delivery item is stopped following contact with the braking roller, and wherein the delivery item is approximately in alignment with additional delivery items.

Further areas of applicability of the present disclosure will become apparent from the detailed description provided hereinafter. It should be understood that the detailed description and specific examples, while indicating some typical aspects of the disclosure, are intended for purposes of illustration only and are not intended to limit the scope of the disclosure.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a Front View of a conventional sorting machine, according to the prior art.

FIG. 2 illustrates a Top View of an example improved sorting machine, according to one of more implementations disclosed.

FIG. 3 illustrates an Auxiliary View of an example improved sorting machine of FIG. 2, according to one or more implementations disclosed.

FIG. 4 illustrates a close up Elevated Rear View of an example improved sorting machine of FIG. 2, according to one or more implementations disclosed.

FIG. 5 illustrates a left facing Front View of an example improved sorting machine of FIG. 2, according to one or more implementations disclosed.

FIG. 6 illustrates an example process flow diagram for sorting delivery items, according to one or more implementations disclosed.

### DETAILED DESCRIPTION

The following description of various typical aspect(s) is merely descriptive in nature and is in no way intended to limit the disclosure, its application, or uses.

As used throughout this disclosure, ranges are used as shorthand for describing each and every value that is within the range. It should be appreciated and understood that the description in a range format is merely for convenience and brevity, and should not be construed as an inflexible limitation on the scope of any embodiments or implementations disclosed herein. Accordingly, the disclosed range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

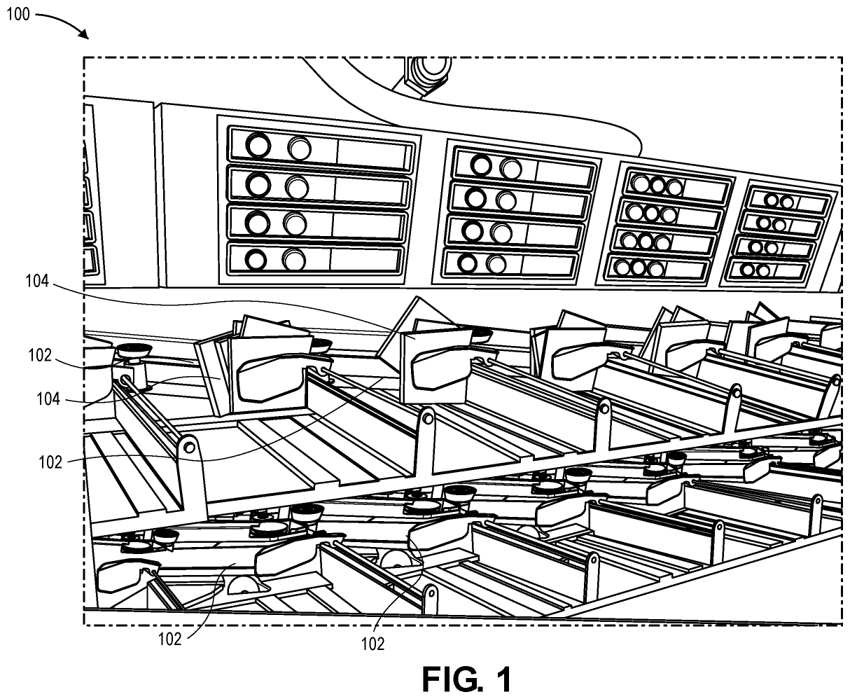

FIG. 1 illustrates a front perspective view of a conventional sorting machine. The sorting machine 100 can include any suitable number of output bins 102 that collect delivery items 104, such as envelopes and the like. In some embodiments, the delivery items 104 are transported along a series of high-speed belts (not depicted) that are located behind each of the output bins 102. The delivery items 104 can be almost any items for delivery, which can include magazines, catalogs, letters, mail pieces, and the like.

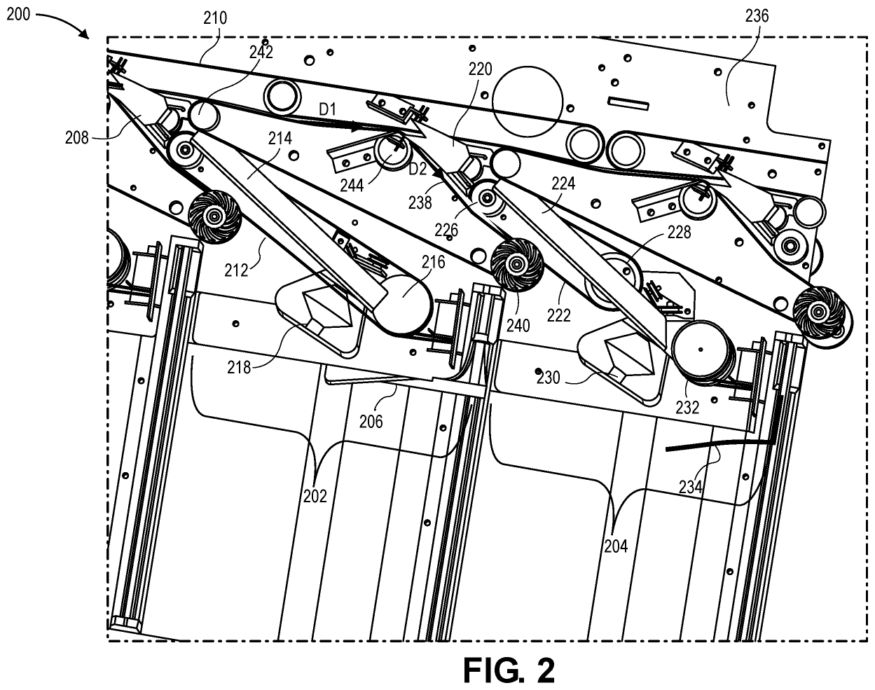

In some embodiments, diverters (not depicted) are proximate the series of high-speed belts and each diverter can direct, reroute, or place the delivery items 104 into separate bins 102. For example, a diverter can be any suitable component that directs, deflects, or routes a delivery item 104 from the series of high-speed belts (not depicted) to an output bin 102. Examples of diverters and belts are illustrated below in relation to FIGS. 2-5. In some examples, the output bins 102 can collect and hold any suitable number of mails items 104. For example, the output bins 102 can each collect a row or stack of delivery items 104 as the delivery items are diverted into each of the output bins 102. As illustrated in FIG. 1, conventional sorting machines direct and transport delivery items 104 directly from the high-speed belt into the output bins 102, without slowing the delivery items 104 before they hit the backstops or the sides of the output bins. As a result of the high-speed impact, (such as about 3.7 m/s, 4 m/s, or higher), with the backstops and/or sides of the output bins, the delivery items 104 become skewed and crooked and unaligned with respect to each output bin and each other, forming a stack or row wherein each delivery item is generally, and often substantially, unaligned delivery item with the other delivery items in the stack or row, as shown in FIG. 1.

It is to be understood that the conventional sorting machine 100 of FIG. 1 is included for illustrative purposes only. The conventional sorting machine 100 can include any number of output bins 102 arranged in any suitable number of rows and/or columns.

Various embodiments of the devices and techniques described herein sorting machine slow the speed of the delivery items 104 as the delivery items 104 enter an output bin 102. Various embodiments of the devices and techniques described herein slow the delivery items 104 sufficiently such that the delivery items 104 form rows or stacks wherein the delivery items 104 are substantially or approximately aligned or mostly aligned with each other; e.g., the edges of the delivery items 104 in an output bin 102 align with each other, plus or minus 15 mm or less (e.g., +/−10 mm, +/−5 mm, etc.), unlike what is shown in FIG. 1. Various embodiments of the devices and techniques described herein may be advantageously added to a conventional sorting machine, improving its output capabilities, and improving the efficiency of the sorting process.

FIG. 2 illustrates a top view of an example of a device or apparatus that is part of, or that may be added onto or used to modify, a delivery-item sorting machine, (e.g., a sorting machine) according to one of more implementations disclosed. For example, the sorting machine 200 of FIG. 2 can include a conventional output bin 202 and an improved output bin 204 that is consistent with the principals of the invention sorting machine. In some embodiments, the sorting machine 200 may include a set of improved output bins 204, a set of conventional output bins 202, or any combination thereof.

In some examples, the conventional output bin 202 can collect or stack or line up delivery items 104 (not shown in FIG. 2) against a backstop 206. For example, a diverter 208 can divert a delivery item 104 (not shown) traveling in direction D1 from a high-speed distribution belt 210 (e.g., about 4 m/s or faster) to a conventional transport belt 212, which moves at approximately the same speed as the high-speed distribution belt 210. In some embodiments, a delivery item 104 is diverted from the distribution belt 210 to the conventional transport belt 212 in response to previously reading a bar code on the delivery item 104 or other sorting control signal. The bar code can indicate a location to receive the delivery item 104, such as a mail transport level, a bin number, and the like. In some examples, a light barrier assembly (not depicted) can read the bar code on the delivery item 104 upstream of the diverter 208 and trigger the diverter 208 to open at the proper time, i.e., to timely redirect, reroute, or move the delivery item 104 from the high-speed distribution belt 210 into the output bin 202 via the conventional transport belt 212.

The diverted delivery item 104 (not shown) can pass along the conventional guide bracket 214 as the delivery item 104 is transported along the conventional transport belt 212. The delivery item 104 can pass between a conventional auger assembly 218 and the conventional guide bracket 214 before passing the conventional roller guide 216 and being stopped by, and deposited against, the backstop 206. Since the conventional roller guide 216 rotates at the same speed as the conventional auger assembly 218 and the conventional transport belt 212, the delivery items 104 are deposited against the backstop 206 with a speed that is high enough to cause the delivery items 104 to rebound, deflect, bounce, or ricochet off of or away from the backstop 206 in various directions. Consequently, when the conventional output bin 202 collects or stacks delivery items 104 against the backstop 206, the delivery items 104 are deposited or oriented in a disorderly manner in which the edges of the delivery items 104 are significantly out of alignment with each other, for example, by 25 mm or more, as is shown, for example, in FIG. 1, where a conventional sorting machine and output bin have deposited or positioned the delivery items 104 proximate to one another at significantly different angles, many of which cause portions of the edges to be misaligned by 25 mm or more.

Referring again to FIG. 2, to avoid misalignment of the delivery items, a diverter 220 can divert the delivery items 104 (not shown) traveling in direction D1 into the improved output bin 204. In some examples, as the diverted delivery items 104 pass in direction D1 between the high-speed distribution belt 210 and a portion of a secondary belt 238, the delivery items 104 are directed or diverted by the diverter 220 to pass between a shortened transport belt 222 and another portion of the secondary belt 238 in direction D2. In some embodiments, the secondary belt 238 can rotate around or be rotatably coupled to secondary rollers or pulleys 240, 242, and 244. The term rollers, as referred to herein, can include any suitable idler pulley, drive pulley, or bend pulley, among others. The secondary belt 238 can provide friction to move the delivery items 104 traveling in direction D2, and to transport the delivery items 104 along the shortened transport belt 222. In some embodiments, any number of rollers or pulleys can drive the secondary belt 238.

In the example shown, the delivery items 104 that are diverted toward the improved output bin 204 pass along the shortened transport belt 222 and along an improved guide bracket 224. In various implementations, the improved guide bracket 224 is shorter in length than the conventional guide bracket 214, so as to allow room for the inclusion of a braking roller 232, which is described further below. The shortened transport belt 222 can be driven or rotated by any number of rollers, such as transport rollers 226 and 228. The improved guide bracket 224 can be any suitable material, such as metal or plastic, among others, and any suitable width, height, and length. The improved guide bracket 224 can be configured to provide a force against, and to guide, the delivery items 104 that are traveling in direction D2. In some embodiments, the delivery items 104 pass beside and/or over an auger assembly 230 after the delivery items 104 pass along the shortened transport belt 222; e.g., the delivery items pass over at least a portion of the auger assembly 230 that is nearest the end of the improved guide bracket 224. In various embodiments, the auger assembly 230 is essentially the same as, or functions in essentially the same way as, a conventional auger assembly 218.

The auger assembly 230 rotates, in various examples, and provides or exerts a force to an edge or surface (e.g., the lower, trailing edge/surface) of a delivery item 104, for example, due to its screw or auger shape. They auger assembly 230 may help guide the delivery item 104 toward and into initial contact with: the braking roller 232, the bumper pad 234, and/or previous delivery item(s) that are already in the improved output bin 204 in front of the bumper pad 234, and/or the side of the improved output bin 204. In various embodiments, the rotation of the screw-like auger 230 may apply a force to push and/or move the trailing portion of the delivery item, which may cause the trailing portion of the delivery item 104 to move or bend away from the improved guide bracket 224 and the braking roller 232, which clears the path to the braking roller 232 so that the following delivery item can be contacted by the braking roller 232. The force(s) from the auger 230 may help cause the delivery item to obtain or maintain an approximately perpendicular position relative to the side of the improved output bin 204. In various embodiments, the auger assembly 230 can be configured (e.g., via rotation speed, screw thread angle, etc.) to enable only a single delivery item 104 to pass to the braking roller 232 at any point in time, thus providing a clear path for each delivery item 104.

In various examples, as shown in FIG. 2, after the auger assembly 230, the delivery items 104 then pass to and come into contact with a braking roller 232 that may rotate at a slower speed than the auger assembly 230 and with a slower tangential speed than the shortened transport belt 222. In some embodiments, the auger assembly 230 and/or the shortened transport belt 222 can operate at, for example, about 4 m/s, or any other suitable predetermined speed, and the braking roller 232 can operate, for example, at a tangential speed of about 3 m/s or any suitable predetermined speed slower than the auger assembly 230 and/or the shortened transport belt 222. In some implementations, the tangential speed of the auger assembly 230 and/or the linear speed of the shortened transport belt 222 can operate at 4 m/s+/−0.3 m/s, and the braking roller 232 can operate at a tangential speed that is at least 20% less than the belt 222's linear speed, such as 3 m/s+/−0.3 m/s; 2.5 m/s+/−0.3 m/s; 2.0 m/s+/−0.3 m/s, or the like. In various examples, the braking roller 232 touches and reduces the speed of the delivery items 104 before the delivery items contact the bumper pad 234. In some implementations, the braking roller 232 reduces the speed of the delivery items 104 by 20% or more, for example 25%, 30%, 35%, or 50%. By reducing the speed of the delivery items before they hit the bumper pad 234 and/or the side of the improved output bin 204, the braking roller 232 reduces or eliminates the misalignment, skewing, and non-perpendicularity caused by the delivery items 104 being stopped while traveling at a high speed, such as about 4 m/s. In some other embodiments, the auger assembly 230 may alternatively be configured to rotate at a tangential speed that is different than the belt 222's linear speed, for example, similar to the braking roller 232.

In the example shown in FIG. 2, the backstop of the improved output bin 204 includes or is formed of a bumper pad 234, which may be made with a flexible, cushioned, soft, and/or impact-absorbing material, such as rubber or foam or the like. By absorbing some of the impact when the reduced-speed delivery items 104 hit it, the bumper pad 234 helps further reduce or eliminate the misalignment, skewing, and crookedness caused by the reduced-speed delivery items 104 being stopped by the bumper pad 234. Thus, in various embodiments, the braking roller 232 and the bumper pad 234 cause the delivery items to be deposited in the improved output bin 204, e.g., against the bumper pad 234, in a stack or row with aligned or approximately aligned edges. In some embodiments, the side of the improved output bin 204 may also include a flexible, cushioned, soft, and/or impact-absorbing material where the delivery items strike after passing the braking roller 232.

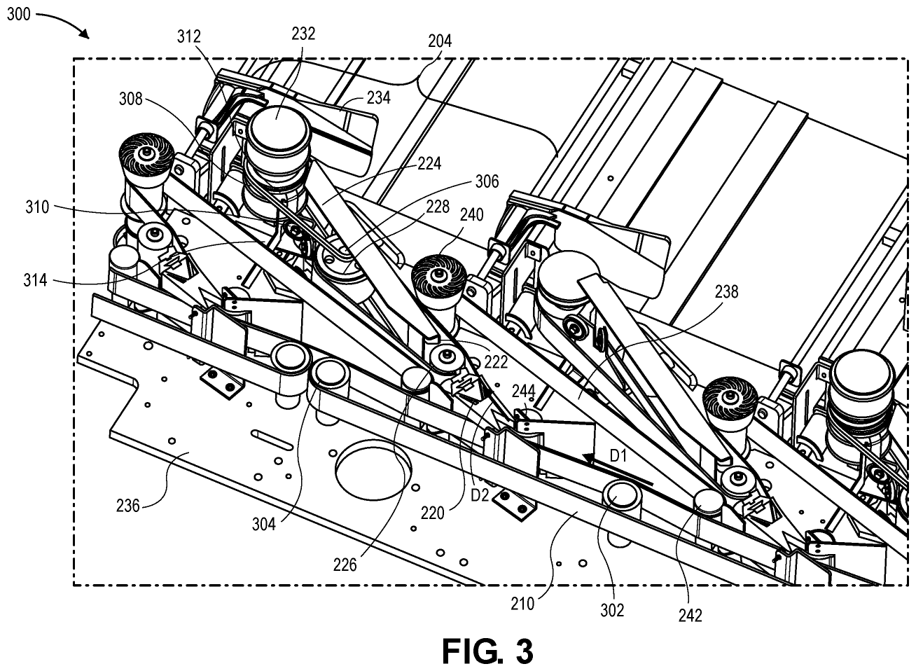

In some embodiments, the braking roller 232 is taller than the conventional roller guide 216 and protrudes farther from the body 236 of the sorting machine 200. In some examples, the taller braking roller 232 can enable coupling the braking roller 232 to the transport roller 228 and processing larger delivery items. In various implementations, as noted previously, the improved guide bracket 224 is shorter in length than the conventional guide bracket 214, which enables the braking roller 232 to extend further from the body 236 of the sorting machine 200. In some examples, the improved guide bracket 224 may not be positioned on top of the braking roller 232. In some embodiments, the braking roller 232 has any number of grooves (not depicted) in which belts (not depicted) rotate the braking roller 232. The grooves and belts that rotate the braking roller 232 are illustrated below in relation to FIGS. 3-5.

In some embodiments, the shortened transport belt 222 can be a flat belt, a v belt, or a synchronous belt, among others. In some examples, the shortened transport belt 222 can be used for power transmission between the transport rollers 226 and 228. For example, a flat shortened transport belt 222 can rotate the transport rollers 226 and 228 based on friction that is generated by a predetermined tension of the flat shortened transport belt 222. For example, one or more of the transport rollers 226 and 228 can be a drive pulley that provides power to drive the transport rollers 226 and 228 and rotates the shortened transport belt 222. The shortened transport belt 222 can be constructed from any number of layers of materials, such as an overcord, an adhesion material, a tensile cord, an undercord, a band or cover, and the like. In some examples, the shortened transport belt 222 can be a narrow v belt in which a height to width proportion is below a threshold ratio, a light duty v belt in which the layers of the light duty v belt are below a predetermined set of height and width dimensions, a banded v belt, or a ribbed v belt, among others. In some embodiments, the shortened transport belt 222 can be a synchronous belt with any suitable tooth profile that interconnects with corresponding grooves in pulleys or rollers, such as transport rollers 226 and 228. In some examples, the tooth profile of the synchronous belt can be a trapezoidal shaped tooth, a curvilinear shaped tooth, or a modified curvilinear shaped tooth, among others. In some examples, the shortened transport belt 222 can also be a link-type belt that includes links, which may be removable, that are joined to adjacent links by interconnected ends. Each link can be constructed from any number of plies of polyester fabric and polyurethane, among other materials.

In some embodiments, the improved output bin 204 can include any number of different rollers. For example, the rollers 226, 228, 232, 240, 242, and 244 of the improved output bin 204 can be any combination of drive pulleys, snub pulleys, tail pulleys, and bend pulleys, among others. The various rollers of the improved output bin 204 can be any suitable shape with any dimensions, such as a cylindrical shape with a diameter and/or length of 2 centimeters, 4 centimeters, or 8 centimeters, among others. In some examples, rollers 226, 228, 232, 240, 242, or 244 that are drive pulleys can provide a driving force for a belt of the improved output bin 204, such as the shortened transport belt 222 or the secondary belt 238. A drive pulley 226, 228, 232, 240, 242, or 244 can have a larger diameter than other rollers of the improved output bin 204. In some examples, the drive pulleys 226, 228, 232, 240, 242, or 244 can have any suitable grooving along the exterior portion of the drive pulleys 226, 228, 232, 240, 242, or 244 to increase friction or grip against flat belts. For example, the drive pulleys 226, 228, 232, 240, 242, or 244 can have a diamond shaped groove, a herringbone shaped groove, and the like. In some examples, the improved output bin 204 can also include rollers that are snub pulleys that can increase or decrease a contact angle of the belt and the drive pulley. For example, a snub pulley can be placed proximate a drive pulley to change the contact angle of the belt and the drive pulley. The improved output bin 204 of FIG. 2 is not illustrated with any snub pulleys.

In some embodiments, a tail pulley can be adjusted to modify a distance between the tail pulley and a drive pulley 226, 228, 232, 240, 242, or 244 to maintain a predetermined tension on a belt connected to the tail pulley and the drive pulley. In some embodiments, the improved output bin 204 can include a bend pulley that can change the direction of a belt. For example, a bend pulley can change the direction of any belt, up to 45 degrees, up to 90 degrees, or up to 135 degrees, among others. Bend pulleys of the improved output bin 204 are described below in relation to FIGS. 3-5.

It is to be understood that the improved sorting machine 200 of FIG. 2 is included for illustrative purposes only. The improved sorting machine 200 can include any number of improved output bins 204 arranged in any suitable number of rows and/or columns. Additionally, the improved sorting machine 200 can include any number of belts, pulleys, rollers, bumper pads, and the like. In some embodiments, the improved sorting machine 200 can include additional transport belts 222, additional transport rollers 226 and 228, and additional braking rollers 232 to contact and reduce the speed of delivery items entering the improved output bins 204. For example, the improved sorting machine 200 can include any number of additional belts, rollers, and the like, to reduce the speed of larger delivery items, such as delivery items in larger containers, or large envelopes (e.g., envelopes larger than 4⅛×9½ inches), among others.

Moreover, it is to be understood that the improved sorting machine 200 can, in some examples, be calibrated based on a speed and/or velocity of the shortened transport belt 222, braking roller 232, and other components of the improved sorting machine 200. For example, a first predetermined speed can indicate a linear speed or velocity of the shortened transport belt 222, and a second predetermined speed can indicate a rotational or tangential speed or velocity of the braking roller 232. In some embodiments, the improved sorting machine 200 can be calibrated based on a speed and/or velocity of delivery items 104 being processed. For example, a first predetermined speed can indicate a speed or velocity of delivery items 104 traveling along the shortened transport belt 222 and a second predetermined speed can indicate a speed or velocity of delivery items 104 that are moving traveling in contact with the braking roller 232.

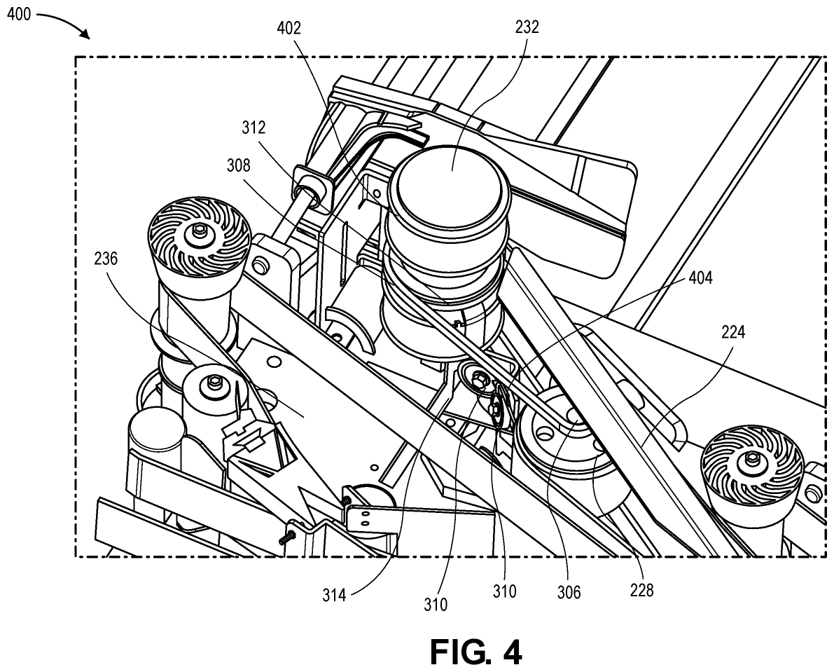

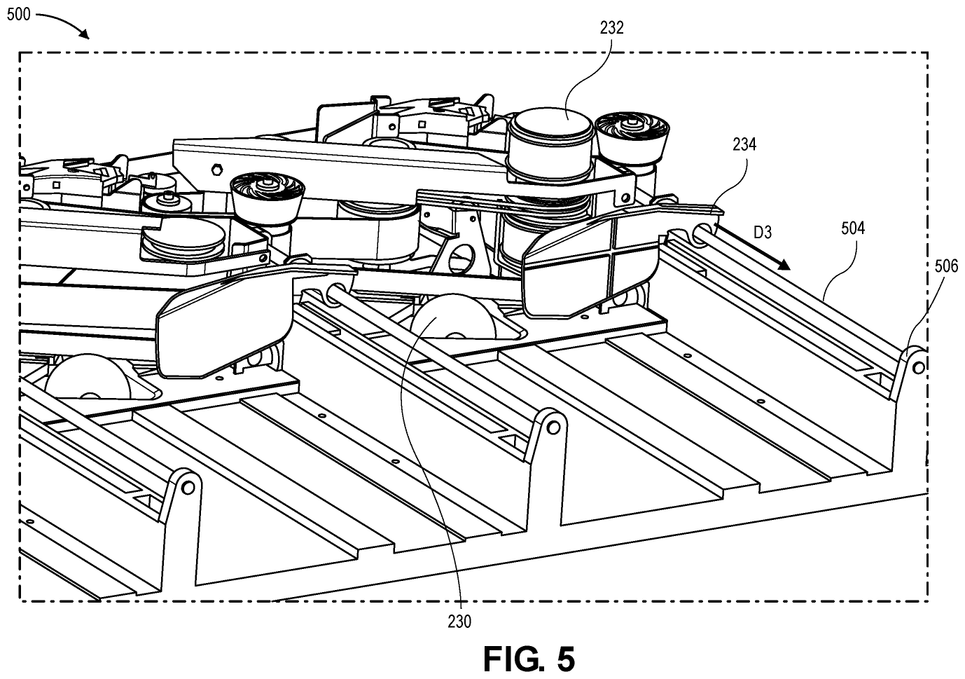

FIG. 3 illustrates an auxiliary view of an example improved sorting machine, according to one of more implementations disclosed. In some embodiments, the distribution belt 210 of the improved sorting machine 300 can be driven by any number of rollers or pulleys such as distribution rollers 302 and 304. In some examples, any number of the distribution rollers 302 and 304 can be drive pulleys or tail pulleys. As discussed above, the delivery items 104 are transported along the distribution belt 210 in direction D1 until the diverter 220 is adjusted to cause or allow the delivery items 104 to pass along direction D2. In some examples, secondary rollers or pulleys 240, 242, and 244 within the secondary belt 238 can apply pressure and friction to delivery items 104 as the delivery items travel past the diverter 220 and along the shortened transport belt 222. The shortened transport belt 222 can rotate around two or more transport rollers 226 and 228. One or more of the transport rollers 226 and 228 can be a drive pulley that provides power to drive the transport rollers 226 and 228 and rotates the shortened transport belt 222. In some examples, one of the transport rollers 226 or 228 includes an extruding mounting post 306 that is connected to the braking roller 232 via a braking roller belt 308. In some examples, the transport roller 228 can also rotate an auger belt (depicted as 404 of FIG. 4) that drives the auger assembly (depicted as 230 in FIGS. 1 and 5). In some embodiments, the auger belt (depicted as 404 of FIG. 4) is routed from the transport roller 228 to the auger assembly (depicted as 230 in FIGS. 2 and 5) via any number of bend pulleys 310 that change the direction of the auger belt (depicted as 404 of FIG. 4). The bend pulleys 310, the auger belt 404, and the auger assembly 230, are illustrated in FIGS. 2 and 4 and described in greater detail below.

In some embodiments, the improved output bin 204 can include one or more braking roller belts 308 that can rotate along the grooves 312 of the braking roller 232. For example, the braking roller belt 308 can connect the braking roller 232 to a transport roller 228 that is connected to the shortened transport belt 222. In some embodiments, the braking roller belt 308 connects to an extruding mounting post 306 of the transport roller 228. Therefore, the braking roller 232 can be an idler pulley that is driven by the transport roller 228 or the braking roller 232 can be connected to a power source (not depicted) that rotates the braking roller 232, and the transport roller 228, which rotates the auger assembly (depicted as 230 in FIGS. 2 and 5). In some embodiments, the bend pulleys 310 are mounted to the body 236 of the sorting machine 300 via any suitable bracket, such as bracket 314.

In some examples, the body 236 may be a single, monolithic piece. The body 236 may be fabricated (e.g., milled or cast) from one or more metals (e.g., a single metal or a metal alloy). The one or more metals utilized to fabricate the body 236 may be at least partially determined by a stiffness or resistance to bending of the body 236 desired and resiliency. For example, the body 236 may be fabricated from high-carbon steel, or from carbon and stainless steel, which may provide high tensile strength, ductility, and stiffness.

It is to be understood that the improved sorting machine 300 of FIG. 3 is included for illustrative purposes only. The improved sorting machine 300 can include any number of improved output bins 204 arranged in any suitable number of rows and/or columns. Additionally, the improved sorting machine 300 can include any number of belts, pulleys, rollers, bumper pads, and the like.

In some embodiments, the various pulleys or rollers of the sorting machine may include a mounting post or stud configured to receive and operably attach or couple the pulleys with the body of the sorting machine. In at least one implementation (not shown), a mounting stud may be integrally formed with the body. In another implementation, a mounting stud may be a separate part that is coupled with the body via any suitable means. For example, the body may define a hole (e.g., a threaded hole) extending through a portion thereof and configured to receive a mounting stud, and the mounting stud may be disposed in the hole and coupled with the body via, for example, an interference or friction fit.

In some embodiments, the pulleys or rollers 226, 228, 232, 240, 242, or 244 of the sorting machine 300 can include or be a generally annular, barrel-shaped, or cylindrical body that is coupled with the body 236 of the sorting machine 300 via a mounting stud (not depicted). The cylindrical body of the pulleys 226, 228, 232, 240, 242, or 244 may be coupled with the mounting stud (not depicted) via any suitable means. For example, the cylindrical body of the pulleys 226, 228, 232, 240, 242, or 244 may be coupled with a mounting stud (not depicted) via a nut (not depicted) configured to mate with the threads of the mounting stud. In at least one implementation, the cylindrical body of the pulleys 226, 228, 232, 240, 242, or 244 may be coupled with the mounting stud (not depicted) via one or more bearings (e.g., rolling element bearings) (not depicted) to facilitate the rotation of the pulley 226, 228, 232, 240, 242, or 244 about the mounting stud.

In some examples, an outer surface of the cylindrical body of the pulleys 226, 228, 232, 240, 242, or 244 may taper radially inward from a centerline towards the axial ends of the pulleys 226, 228, 232, 240, 242, or 244 thereof. As such, a radial length of the cylindrical body of the pulleys 226, 228, 232, 240, 242, or 244 at the centerline may be relatively greater than a radial length at each of the axial ends of the pulleys 226, 228, 232, 240, 242, or 244. In at least one implementation (not depicted), the pulleys 226, 228, 232, 240, 242, or 244 may define a flange (not depicted) disposed at one or both of the axial ends of the pulleys 226, 228, 232, 240, 242, or 244. The flange may be configured to facilitate or maintain contact between the pulleys 226, 228, 232, 240, 242, or 244 and a belt, such as the shortened transport belt 222 or the secondary belt 238, rotating thereon. For example, the flange may keep the belt 222 or 238 from drifting, rotating, or shifting off of (e.g., past an axial end) the pulleys 226, 228, 232, 240, 242, or 244. In some implementations, the pulleys 226, 228, 232, 240, 242, or 244 do not include a flange at the axial ends of the pulleys 226, 228, 232, 240, 242, or 244.

FIG. 4 illustrates a close up elevated rear view of an example improved sorting machine, according to one of more implementations disclosed. The improved sorting machine 400 of FIG. 4 can include any number of improved output bins 204 that correspond to the improved output bin 204 of FIGS. 2 and 3.

In some embodiments, the improved output bin 204 can include an improved guide bracket 224 that can attach to the braking roller 232. The improved guide bracket 224 can be shorter than the conventional guide bracket 214 of FIG. 2, which enables the braking roller 232 to extend above the improved guide bracket 224. In some examples, the improved guide bracket 224 can attach to the braking roller 232 via any suitable means, such as the circular end 402 of the improved guide bracket 224, among others.

In some embodiments, the braking roller 232 is coupled to transport roller 228 via the braking roller belt 308 that rotates between the grooves 312 of the braking roller 232 and the extruding mounting post 306 of the transport roller 228. The size of the transport roller 228 in relation to the size of the braking roller 232 can result in a slower rotational speed of the braking roller 232. For example, a smaller circumference of the transport roller 228 in relation to the circumference of the braking roller 232 can result in the braking roller 232 having a slower rotational speed. Accordingly, a rotational speed or revolutions per minute of the braking roller 232 can be improved by increasing or decreasing the circumference of the braking roller 232 in relation to the circumference of the transport roller 228.

In some examples, the transport roller 228 can rotate the auger assembly 230 and the braking roller 232. For example, the bend pulleys 310 can route the auger belt 404 between the auger assembly 230 (see FIG. 2) and the transport roller 228. In some examples, the auger belt 404 can rotate the auger or auger assembly (depicted as 230 in FIGS. 2 and 5). The auger belt 404 and the auger or auger assembly (depicted as 230 in FIGS. 2 and 5) are described in greater detail below in relation to FIG. 5. (depicted as 230 in FIGS. 2 and 5). In some embodiments, the braking roller 232 and/or the transport roller 228 are attached to the body 236 via bracket 314. The bracket 314 can connect to the body 236 via any number of mounting studs, bolts, and the like. In some examples, the bracket 314 can be coupled to any number of bend pulleys 310.

It is to be understood that the improved sorting machine 400 of FIG. 4 is included for illustrative purposes only. The improved sorting machine 400 can include any number of improved output bins 204 arranged in any suitable number of rows and/or columns. Additionally, the improved sorting machine 400 can include any number of belts, pulleys, rollers, bumper pads, and the like.

FIG. 5 illustrates a left facing front view of an example improved sorting machine, according to one of more implementations disclosed. In some embodiments, the mail sorting mechanism 500 can include an auger assembly 230 that is rotatably connected to the braking roller 232 via an auger belt (shown in FIG. 4). In some examples, the auger belt 404 can be routed from the auger assembly 230 to the braking roller 232 via any suitable pulleys, such as the bend pulleys 310 of FIGS. 3 and 4. In some embodiments, the auger belt 404 can also be rotatably coupled to the transport roller 228.

In some embodiments, as delivery items 104 are deposited against the bumper pad 234, the bumper pad 234 can be forced in a direction D3 along guide post 504. The bumper pad 234 can move along the guide post 504 until the bumper pad 234 contacts an end 506 of the guide post 504. The delivery items can be removed from the improved output bin 204, and the bumper pad 234 can slide along the guide post 504 in the opposite direction of D3, towards the roller guide 232. The improved output bin 204 described herein can enable a stack of delivery items 104 to be deposited along the bumper pad 234 with approximately aligned sides. Accordingly, the improved output bin 204 described herein can prevent a stack of delivery items 104 from forming in which the delivery items 104 are deposited at various angles in an unaligned manner.

It is to be understood that the improved sorting machine 500 of FIG. 5 is included for illustrative purposes only. The improved sorting machine 500 can include any number of improved output bins 204 arranged in any suitable number of rows and/or columns. Additionally, the improved sorting machine 500 can include any number of belts, pulleys, rollers, bumper pads, and the like. In some embodiments, the improved sorting machine 500 can also include a front guide roller adapter that supports and positions the shorter front guide roller; a drive reduction adapter; and an auger reverse drive bracket assembly, among others. For example, a shorter front guide roller or transport roller 228 can be driven by the shorter guide belt or shortened transport belt 222, which can reverse drive the auger 230. In some embodiments, a drive reduction adapter or extruding mounting post 306 is bolted to transport roller 228, and uses two or more belts to drive the braking roller 232 at a reduced tangential speed compared to the speed of the delivery item.

Additionally, it is to be understood that the improved sorting machines 200, 300, 400, and 500 may include any number of the features and components described herein. In some embodiments, the improved sorting machines 200, 300, 400, and 500 are different perspectives of the same improved sorting machine.

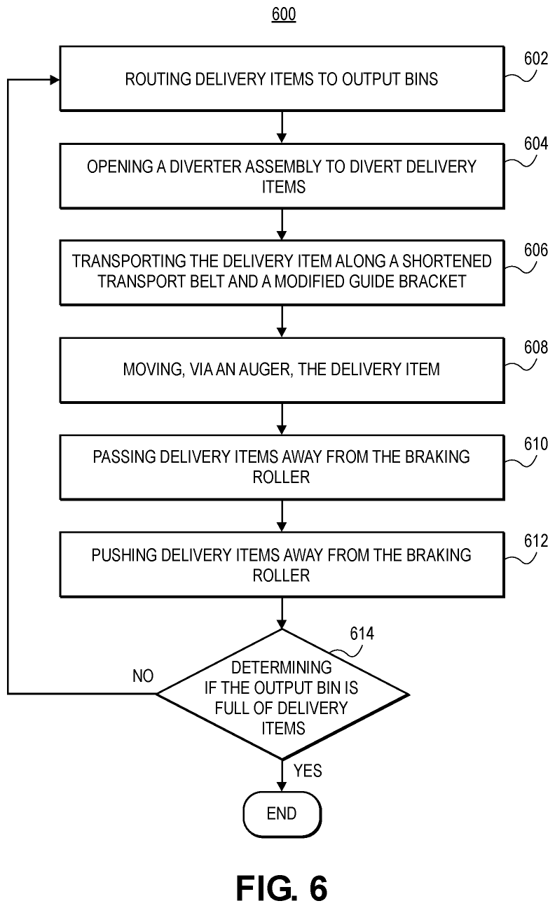

FIG. 6 is a process flow diagram for using a sorting machine to process, sort, and distribute delivery items. In some embodiments, the method 600 can be implemented with the sorting machine 200, 300, 400, or 500.

At block 602, the method can include routing delivery items to output bins based on sort plan pocket data. The sort plan pocket data can indicate a mail transport level and an output bin to receive a delivery item. In some examples, the sort plan pocket data is included in a bar code that is affixed to a delivery item. In some examples, when an output bin matches sort plan pocket data, the output bin or pocket can be cleared to receive a delivery item. In some embodiments, each output bin can include any number of limit switches that can be activated by the passing delivery items to divert a delivery item.

At block 604, the method can include opening or actuating a diverter assembly to divert or deflect delivery items from a mail path along the distribution belt to an output bin. In some examples, the distribution belts of the sorting machine propel the delivery items at a speed of 4 meters per second, or any other suitable speed. In some embodiments, the diverter assembly is moved or opened by any suitable actuator device, among others. For example, a light barrier assembly can upstream read the bar code affixed to the delivery item and trigger a diverter to open.

At block 606, the method can include transporting the delivery item along a shortened transport belt and an improved guide bracket. As discussed above in relation to FIGS. 2-5, the shortened transport belt and the improved guide bracket can transport delivery items from the distribution belt and the transport belt towards and into touch with a braking roller. The shortened transport belt can operate at a same speed as the distribution belt, such as 4 m/s or any other suitable first predetermined speed. In some examples, the improved guide bracket can begin to decelerate the delivery items.

At block 608, the method can include moving, via an auger rotating at the same speed as the distribution belts of the sorting machine, the tail or trailing end of the delivery item. For example, the auger may bend or move the delivery item out of the way of the following delivery item so that the following delivery item can contact the braking roller. In some such embodiments, the auger can move the delivery item to prevent the delivery item from interfering with a subsequent incoming delivery item and to optimize the quality of the stack of items in the output bin, for example, by better aligning them with each other and with the side of the sorting bin.

At block 610, the method can include passing the delivery item along or in contact with a braking roller. In some embodiments, the braking roller can rotate at a slower speed than the distribution belts and/or transport belts of the sorting machine. For example, the braking roller can rotate at less than 50% of the speed of the distribution belts and/or transport belts of the sorting machine. In some embodiments, the braking roller can rotate at a second predetermined speed, such as 3 m/s, among others. In some examples, the braking roller can also be calibrated to rotate at a second predetermined speed that slows a delivery item by a particular amount. For example, the braking roller can be calibrated to rotate at a second predetermined speed, which slows the speed of a delivery item 3 m/s, or any other suitable speed or velocity. The rotational speed of the braking roller can be determined based on a circumference of the braking roller compared to a circumference of a transport roller driving the braking roller. For example, the braking roller can rotate more slowly as the circumference of the braking roller increases in relation to the circumference of the transport roller driving the braking roller. In some examples, the braking roller can guide delivery items to a bumper pad that stops the momentum of the delivery item and brings the delivery item to stopped position.

At block 612, the method can include pushing, via a solenoid pusher assembly, grooves 312 of a braking roller 232, or any suitable portion of a braking roller 232, which is activated at the same time as the diverter, delivery items away from the braking roller. In some examples, the solenoid pusher assembly can be active for a duration of approximately 200 MS longer than the diverter, or any other suitable time period. The solenoid pusher assembly can prevent mail frictional damage to the delivery items. In some examples, the delivery items are in a stacked position in the output bin and stay in position until the delivery items are pushed out away from the braking roller by subsequent incoming delivery items.

At block 614, the method can include determining if the output bin is full of delivery items. If the sorting machine can store additional delivery items, the process returns to block 602. If the sorting machine cannot store additional delivery items, the process ends. The method 600 provides enhanced control of various types of delivery items and enables the delivery items to be deposited in an output bin with substantially aligned sides.

The method 600 can include any number of additional or fewer blocks. In some examples, the method 600 can improve conventional methods by slowing the speed of the delivery items so that the delivery items are collected in a stack in which the edges of the delivery items are approximately aligned. The method 600 can be implemented with a sorting machine that includes a shortened transport belt, and a brake guide roller, among other components described herein. In some embodiments, the method 600 can include reducing a speed and/or velocity of a delivery item as the delivery item passes through the improved sorting machine.

The present disclosure has been described with reference to example implementations. Although a limited number of implementations have been shown and described, it will be appreciated by those skilled in the art that changes may be made in these implementations without departing from the principles and spirit of the preceding detailed description. It is intended that the present disclosure be construed as including all such modifications and alterations insofar as they come within the scope of the appended claims or the equivalents thereof.

What is claimed is:

1. A sorting machine for delivery items, the sorting machine comprising an output bin comprising:
a transport belt to transport a delivery item from a distribution belt toward a braking roller at a first predetermined speed;
the braking roller to reduce a speed of the delivery item by operating at a second predetermined tangential speed that is slower than the first predetermined speed;
an auger assembly positioned between the transport belt and the braking roller, wherein the auger assembly applies a force to the delivery item to clear a path to the braking roller; and
a bumper pad to stop the delivery item, wherein the delivery item is stopped against the bumper pad following contact with the braking roller, and wherein the delivery item is stopped approximately in alignment with additional delivery items.

2. The sorting machine of claim 1, further comprising:
a transport roller; and
a braking roller belt operably coupled to the braking roller and the transport roller, the braking roller belt to rotate the braking roller at the second predetermined tangential speed.

3. The sorting machine of claim 1, further comprising a guide bracket to guide the delivery item from the transport belt to the braking roller.

4. The sorting machine of claim 3, wherein the braking roller protrudes from the sorting machine above the guide bracket.

5. The sorting machine of claim 4, wherein the guide bracket is coupled to the braking roller via one or more circular ends.

6. The sorting machine of claim 1, comprising
a transport roller; and
an auger belt operably coupled to the auger assembly and the transport roller;
wherein the auger assembly comprises an auger, and the auger belt is configured to drive the auger; and
wherein the force applied by the auger assembly includes a force applied to a trailing portion of the delivery item.

7. The sorting machine of claim 6, comprising a bracket assembly comprising one or more pulleys operably coupled to the auger belt.

8. The sorting machine of claim 1, further comprising a distribution belt, and a secondary belt proximate the transport belt, wherein the secondary belt and the transport belt transport the delivery item from the distribution belt toward the auger assembly.

9. The sorting machine of claim 1, further comprising a diverter that diverts the delivery item from a distribution belt to the output bin.

10. A method for sorting delivery items with a sorting machine, the method comprising:
transporting, via a transport belt, a delivery item from a distribution belt toward a braking roller at a first predetermined speed;
operating the braking roller at a second predetermined tangential speed that is slower than the first predetermined speed;
reducing a speed of the delivery item by contact with the braking roller;
stopping, via a bumper pad, the delivery item, wherein the delivery item is approximately in alignment with additional delivery items; and
applying, via an auger assembly, a force to the delivery item to clear a path to the braking roller.

11. The method of claim 10, wherein operating the braking roller comprises:
rotating the braking roller via a braking roller belt, wherein the braking roller belt is operably coupled to the braking roller and a transport roller that is rotatably coupled to the transport belt.

12. The method of claim 10, further comprising guiding, via a guide bracket, the delivery item from transport belt to the braking roller.

13. The method of claim 12, wherein the braking roller protrudes from the sorting machine above the guide bracket.

14. The method of claim 10, wherein the auger assembly comprises an auger, and wherein applying, via the auger assembly, the force to the delivery item comprises:
applying, using the auger, a force that is perpendicular to the direction of travel of the delivery item, wherein the force causes at least a portion of the delivery item to move away from the braking roller; and
driving the auger with an auger belt operably coupled to the auger assembly and a transport roller.

15. The method of claim 10, wherein transporting, via the transport belt, the delivery item from the distribution belt toward the braking roller at the first predetermined speed further comprises:
transporting the delivery item from the distribution belt toward the braking roller via a secondary belt proximate the transport belt.

16. The method of claim 10, further comprising directing, via a diverter, a delivery item from a distribution belt to an output bin.

17. A sorting machine comprising:
a diverter that directs a delivery item from a distribution belt toward an output bin, wherein the output bin comprises:
a transport belt to transport the delivery item from the distribution belt toward a braking roller at a first predetermined speed;
the braking roller to reduce a speed of the delivery item by operating at a second predetermined tangential speed that is slower than the first predetermined speed, the braking roller comprising a mounting post that is connected to the braking roller via a braking roller belt;
an auger assembly, positioned between the transport belt and the braking roller, to apply a force to the delivery item to clear a path to the braking roller, wherein the auger assembly is operably coupled to an auger belt and a transport roller; and
a bumper pad to stop the delivery item, wherein the delivery item is stopped following contact with the braking roller, and wherein the delivery item is approximately in alignment with additional delivery items.

18. The sorting machine of claim 17, wherein the braking roller protrudes from the sorting machine above the guide bracket; and
wherein the auger assembly applies a force to move a trailing portion of the delivery item, which causes at least a portion of the delivery item to move away from the braking roller.

19. The sorting machine of claim 17, further comprising:
the braking roller belt operably coupled to the braking roller and the transport roller, the braking roller belt to rotate the braking roller at the second predetermined tangential speed.

20. The sorting machine of claim 17, further comprising a secondary belt proximate the transport belt, wherein the secondary belt and the transport belt transport the delivery item from the distribution belt toward the output bin.
